(19) United States
(12) Patent Application Publication
(10) Pub. No.: US 2016/0039027 A1
(43) Pub. Date: Feb. 11, 2016

(54) PIEZOELECTRIC WIRE EDM

(71) Applicant: YA-YANG YEN, Taichung City (TW)

(72) Inventor: YA-YANG YEN, Taichung City (TW)

(21) Appl. No.: 14/724,225

(22) Filed: May 28, 2015

Related U.S. Application Data
(63) Continuation-in-part of application No. 14/519,365, filed on Oct. 21, 2014.

(30) Foreign Application Priority Data
Jun. 10, 2014 (TW) 103119990
Dec. 20, 2014 (CN) 201410791802.9

(51) Int. Cl. B23H 1/06; C22F 1/08; B21C 1/02; C25D 11/34; B23H 7/08; B23H 7/24

(52) U.S. Cl. CPC B23H 1/06; B23H 7/08; B23H 7/24; B21C 1/02; C25D 11/34; C22F 1/08

(57) ABSTRACT

An electrode wire and a process of making a wire EDM machine tool electrode for use in an electric discharge machining apparatus includes a metallic core and a piezoelectric responsive coating disposed on the core.

### RELATED APPLICATIONS

This application claims priority to Chinese Patent Appln. No. 201410791802.9, filed Dec. 20, 2014, U.S. patent application Ser. No. 14/519,365, filed Oct. 21, 2014, and Taiwanese Patent Appln. No. 103119990, filed Jun. 10, 2014, the entirety of which are incorporated herein by reference.

### FIELD OF THE INVENTION

This invention relates to electrical discharge machining (EDM) and specifically to an electrode wire to be used in discharge machining and to the process for manufacturing an EDM electrode wire.

### BACKGROUND

The process of electrical discharge machining (EDM) is well known. In the field of traveling wire EDM, an electrical potential (voltage) is established between a continuously moving EDM wire electrode and an electrically conductive work piece. The electrical potential is raised to a level at which a discharge is created between the EDM wire electrode and the work piece. The intense heat generated will melt and/or vaporize a portion of both the work piece and the wire to thereby remove, in a very small increment, a piece of the work piece. By generating a large number of such discharges, a large number of increments are removed from the work piece whereby the work piece can be cut very exactly to have a desired planar contour. A dielectric fluid is used to establish the necessary electrical conditions to initiate the discharge and to flush debris from the active machining area.

The residue resulting from the melting and/or vaporization of a small increment (volume) of the surface of both the work piece and the EDM wire electrode is contained In a gaseous envelope (plasma). The plasma eventually collapses under the pressure of the dielectric fluid. The liquid and the vapor phases created by the melting and/or vaporization of material are quenched by the dielectric fluid to form solid debris. The cutting process therefore involves repeatedly forming a plasma and quenching that plasma. This process will happen sequentially at microsecond intervals at many spots along the length of the EDM wire.

It is important for flushing to be efficient because, if flushing is inefficient conductive particles build up in the gap, which, can create the potential for electrical arcs. Arcs are very undesirable as they cause the transfer of a large amount of energy, which causes large gouges or craters, i.e., metallurgical flaws, to be introduced into the work piece and the EDM wire electrode. Such flaws in the wire could cause the EDM wire to break catastrophically.

An EDM wire must possess a tensile strength that exceeds a desired threshold value to avoid tensile failure of the wire electrode induced by the preload tension that is applied. The EDM wire should also possess a high fracture toughness to avoid catastrophic failure induced by the flaws caused by the discharge process. Fracture toughness is a measure of the resistance of a material to flaws, which may be introduced into the material and can potentially grow to the critical size capable of causing catastrophic failure of the material. The desired threshold tensile strength for an EDM wire electrode is thought to be in the range of about 60,000 to 90,000 psi.

It is known in the prior art to use an EDM wire electrode with a core composed of a material having a relatively high mechanical strength with a relatively thin metallic coating covering the core and comprising at least 50% of a metal having a low volumetric heat of sublimation such as zinc, cadmium, tin, lead, antimony, bismuth or an alloy thereof. Such a structure is disclosed is U.S. Pat. No. 4,287,404, which discloses a wire having a steel core with a coating of copper or silver that is then plated with a coating of zinc or other suitable metal having a low volumetric heat of sublimation. As experience was gained with zinc coated wire electrodes. U.S. Pat. No. 4,341,939 described the advantage of a thin film of ZnO (less than 1μ in thickness) on a coating of Cu—Zn alloy. It was reported that favorable results were not limited to zinc oxide and that other metallic oxides also known as being semi-conductors, for example CuO, Cu₂O, CdO, In₂O₃, PbO, TiO₂, MnO₂, MgO, and NiO, can be used. In U.S. Pat. No. 4,977,303 the same inventor acknowledged that “such oxidizing treatments has not increased the machining speed to the degree expected” (see Col 1, Lines 44-46).

It is also known from the prior art, for instance from U.S. Pat. No. 4,686,153, to coat a copper clad steel wire with zinc and thereafter to heat the zinc coated wire to cause inter-diffusion between the copper and zinc to convert the zinc layer into a copper zinc alloy. That patent describes the desirability of a beta phase alloy layer for EDM purposes. The copper zinc has a zinc concentration of about 45% by weight with the zinc concentration decreasing radially inward from the outer surface. The average zinc concentration in the copper zinc layer is less than 50% by weight but not less than 10% by weight. The surface layer therefore includes beta phase copper-zinc alloy material, at the outer surface since beta phase copper zinc alloy material has a zinc concentration ranging between 40%-50% by weight. While this patent recognized that a copper-zinc alloy layer formed by means of a diffusion anneal process could potentially contain epsilon phase (approximately 80% zinc content), gamma phase (approximately 65% zinc content), beta phase (approximately 45% zinc content), and alpha phase (approximately 35% zinc content), the patent asserted that the preferred alloy material is beta phase in the coating.

Others in the prior art, for instance U.S. Pat. No. 5,762,726, recognized that the higher zinc content phases in the copper-zinc system, specifically gamma phase, would be more desirable for EDM wire electrodes. However, the inability of the EDM wire to cope with the brittleness of gamma phase limited the commercial feasibility of manufacturing such wire.

This situation changed with the technology disclosed in U.S. Pat. No. 5,945,010. By employing low temperature diffusion anneals, the inventor was able to incorporate brittle gamma phase particles in a coating on various copper containing metallic substrates. Since this advancement, there have been no metallurgical advances in the art as researchers simply proposed wire constructions that involve various combinations of beta phase, gamma phase, and zinc in the coating layer (e.g., U.S. Pat. No. 7,723,635, U.S. Pat. No. 8,378,247, U.S. Pat. No. 8,445,807, U.S. Pat. No. 8,067,689, and U.S. Pat. No. 8,822,872).

In the same time period, the development of aerospace and medical application for the EDM process has created the desire for a zinc-free wire type for the wire EDM process since zinc contamination in EDM processed work pieces in these industries has increasingly become an Issue. This issue is exasperated by the high cost and poor performance of alternatives, primarily molybdenum and titanium or anodized titanium wires.

The phenomenon of piezoelectricity is also well known. Piezoelectricity was discovered in 1880 by French physicists Jacques and Pierre Curie. The piezoelectric effect is the internal generation of an electrical charge resulting from an applied mechanical force. It occurs in crystalline materials, which lack a center of symmetry in their crystalline structure. The piezoelectric effect is a reversible process in mat materials exhibiting the direct effect also exhibit the reverse piezoelectric effect, i.e., the internal generation of a mechanical strain resulting from an applied electrical field.

Compounds with the hexagonal wurtzite crystal structure, for example GaN, InN, AlN, and ZnO, are known to exhibit the piezoelectric effect. The phenomenon of piezoelectricity has been studied extensively over the years because of its application in electronic sensors, actuators, motors, and a host of other sophisticated applications, in particular, devices utilizing the piezoelectric character of ZnO have been developed (see U.S. Pat. No. 4,783,821; U.S. Pat. No. 4,816,125; and U.S. Pat. No. 6,121,713). However, there are only a few references to the application of piezoelectricity to the EDM application. U.S. Pat. No. 5,773,781 described incorporating a piezoelectric devise on the side of the tool electrode or the workplace whereby relative motion with a displacement much smaller than the size of the gap can be induced during machining to increase the metal removal rate in the EDM sinking application, U.S. Pat. No. 7,019,247 described employing the use of piezo motors to advance the tool electrode in the EDM sinking application to achieve more precise position control. Although there have been no references to piezoelectric application to the traveling wire EDM application, U.S. Pat. No. 6,121,713 described the advantages of utilizing a high frequency vibration in the wire electrode to prevent wire breaks and enhance cutting speed in a series of U.S. Patents (see U.S. Pat. No. 4,205,213; U.S. Pat. No. 4,321,450; and U.S. Pat. No. 4,383,159). In all of these eases an external electromagnetic or ultrasonic vibrator imposed the vibration on the wire electrode.

As was previously noted, there are multiple references in the prior art directed to the advantages of thin zinc oxide coatings where “thin” is defined as ranging between 100 nm and about 250 nm, i.e., 0.1 to 0.25 μm (Col. 5, Lines 46-47 of U.S. Pat. No. 8,378,247) and about 1 micrometer thick (Col. 4, Lines 15-16 in U.S. Pat. No. 4,977,303). The last reference had raised his earlier estimate of less than 1μ in thickness (Col. 2, Line 60 of U.S. Pat. No. 4,341,939) to about 1 micrometer thick between 1980 and 1988. It is more than very interesting that not one of these references offered any data to confirm their assertion of a thin oxide film advantage. The speculated advantage of such a “thin oxide” coating was that their “semi-conductor” character prevented “short circuits” as the discharge phenomenon progresses (Col. 3-4 of U.S. Pat. No. 4,341,939).

As previously mentioned, this same inventor later admitted such oxidizing treatments has not increased the machining speed to the degree expected (Col. 1, Lines 44-46 of U.S. Pat. No. 4,977,303). Interestingly enough, the result of U.S. Pat. No. 4,977,303 was the so called “diffusion annealed wire types X and D”, which retained the oxidized surface film on the wire, giving it the distinctive tan brown color, but providing increased machining speed by employing a beta phase coating with it lower volumetric heat of sublimation. Unfortunately it also perpetuated the myth of the advantage of “a thin film ZnO semi-conductive oxide.”

In point, of fact in the mid-1990's, Rea Magnet Wire Company (located in Ft. Wayne, Ind.) attempted to test market a clean, e.g., un-oxidized version of D-Type to compete with the then market dominate D-Type wire. Cobra Cut D manufactured by Berkenhoff GmbH (located in Germany). Rea diffusion annealed the wire in an inert atmosphere (nitrogen gas) and tested It against the Cobra Cut D wire. The un-oxidized and oxidized versions had identical cutting performances. The product, however, was never introduced because it did not look like D-Type wire and could not gain market acceptance.

The fact remains that the prior art of U.S. Pat. No. 4,341,939, U.S. Pat. No. 4,977,303 and U.S. Pat. No. 8,378,247 were and remain questionable with regard to “thin film zinc oxide advantage”. Regardless of the validity of the “semi-conductor” mechanism that has been proposed in U.S. Pat. No. 4,341,939, it cannot be interpreted as a piezoelectric phenomenon as evidenced by the listing of other “semi-conductor” species (CuO, Cu₂O, CdO, In₂O₃, PbO, TiO₂, MnO₂, MgO, and NiO), none of which are piezoelectric responsive.

### SUMMARY OF THE INVENTION

In accordance with an embodiment of the present invention an electrode wire for use in an electric discharge machining apparatus includes a metallic core and a piezoelectric responsive coating disposed on the core.

In accordance with another embodiment an electrode wire for use in an electric discharge machining apparatus includes a metallic core and an intermediate brass alloy layer disposed on the core and having a zinc content greater than 40 weight per cent. A piezoelectric responsive coating is disposed on the intermediate brass alloy layer.

In accordance with another embodiment a process for producing a wire EDM machine tool electrode includes providing a metallic core and covering the core with a layer of zinc using an electrolytic process in order to produce a preblank. The preblank is wire drawn to reduce its diameter. The wire-drawn preblank is resistively annealed in a dielectric water bath at a speed and electrical current configured to produce a gamma phase brass layer over the core and oxidize the zinc into a ZnO coating over the brass layer with a minimum, thickness of 2 μm.

In accordance with another embodiment a process for producing a wire EDM machine tool electrode includes providing a metallic core and covering the core with a layer of zinc using an electrolytic process in order to form a preblank. The preblank is subjected to a first wire drawing operation to reduce its diameter to an intermediate diameter. The wire-drawn preblank is resistively annealed in a dielectric water bath at a speed and electrical current configured to produce one of a gamma phase brass layer and a beta phase brass layer over the core as well as oxidize the zinc into a ZnO coating over the brass layer with a minimum thickness of 2 μm. The preblank is subjected to a second wire drawing operation to reduce its diameter to one appropriate for a wire EDM machine tool electrode.

### BRIEF DESCRIPTION OF THE DRAWINGS

The above mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration forming system for constructing a core-sheath wire EDM electrode according to the present invention;

FIG. 2 is a metallurgical cross-section of an example EDM wire formed from the system of FIG. 1.

FIG. 3 is a metallurgical cross-section of another example EDM wire formed from the system of FIG. 1.

FIG. 4 is a metallurgical cross-section of yet another example EDM wire formed from the system of FIG. 1.

FIG. 5 is a metallurgical cross-section of yet another example EDM wire formal from the system of FIG. 1.

FIG. 6 is a metallurgical cross-section of yet another example EDM wire formed from the system of FIG. 1.

FIG. 7 is a schematic drawing of a test pattern used for performance testing the EDM wire.

### DESCRIPTION OF THE PREFERRED EMBODIMENT

The present invention is the result of the surprising observation that the essential character of the wire EDM process, e.g., the imposition of high frequency voltage pulses on a conductive wire electrode, can be further exploited to improve the flushing action in the gap between the electrode and the work piece by adding a piezoelectric responsive element to the wire electrode's surface. By so doing one can potentially address the major short comings of the current state of the art, e.g., make a significant metallurgical improvement in the construction of the Cu/Zn wire electrodes and provide a vehicle to achieve high performance zinc-free wire constructions.

According to the invention, by creating a surface layer of piezoelectric responsive elements, the reverse piezoelectric process will be activated by the high frequency voltage pulses imposed on the wire electrode in the EDM machining process resulting in a high frequency distortion in of the wire electrode which is advantageous in the flushing process that removes solid debris from the gap between the wire electrode and the work piece.

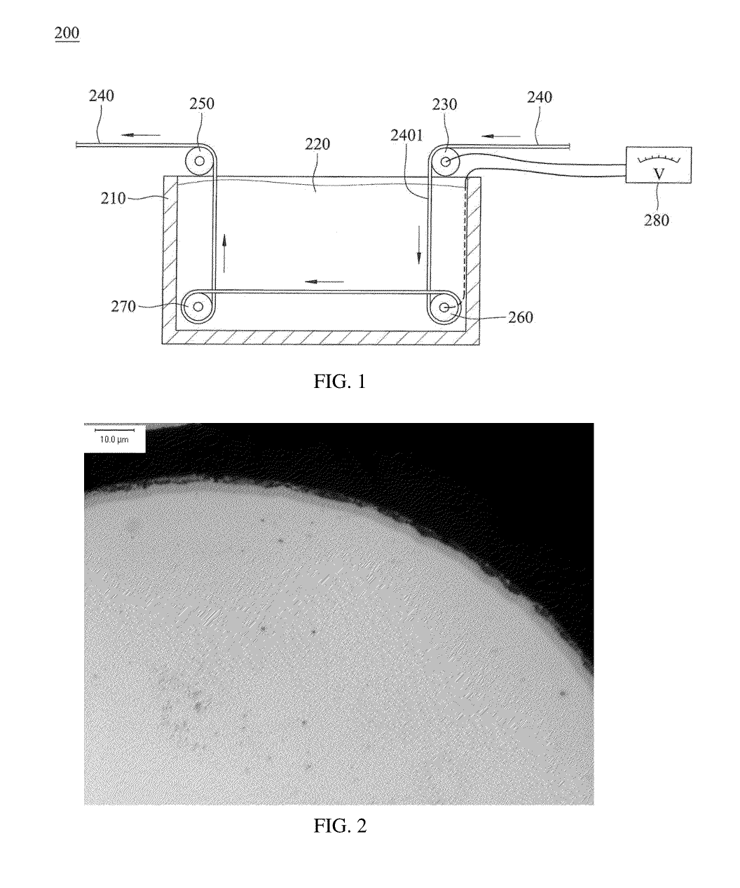

It is well known that zinc oxide (ZnO) is piezoelectric responsive although, as with any piezoelectric material, the strength of that response is difficult to predict. In order to access the potential of piezoelectric response of ZnO films on brass EDM electrodes in the EDM application, the apparatus described in FIG. 1 was constructed to create a system for oxidizing a zinc-coated brass EDM wire in a controlled manner, thereby forming a piezoelectric ZnO surface layer.

As illustrated in FIG. 1, a zinc-coated brass wire 240 is introduced into a liquid container 210 containing a liquid bath 220 of a dielectric liquid. A guiding roller unit guides and brings a strip 240 of core-sheath wire preform into, through and out of the liquid bath 220. A motor (not shown) drives movement of the strip 240 of the core-sheath wire preform.

The guiding roller unit includes a conductive inlet guiding roller 230, an outlet-guiding roller 250, a conductive first guiding roller 260, and a conductive second guiding roller 270. The first and second guiding rollers 260, 270 are immersed in the liquid bath 220. The inlet guiding roller 230 and the outlet guiding roller 250 are disposed above the liquid bath 220. Each of the inlet guiding roller 230 and the first guiding roller 260 serves as a conductive guiding means. The metal layer of the core-sheath wire preform strip 40 can be heated by connecting the inlet guiding roller 230 and the first guiding roller 260 to a power source 280, followed by sliding the strip 240 of the core-sheath wire preform on the inlet-guiding roller 230. The first guiding roller 260 then applies a potential difference between the inlet guiding roller 230 and the first guiding roller 260 using the power source 280 to cause a short circuit therebetween through bridging a portion 2401 of the strip 240 of the core-sheath wire preform disposed between the inlet guiding roller 230 and the first guiding roller 260, which results in the portion 2401 of the strip 240 being heated.

The heated strip 240 of the core-sheath wire preform is continuously driven by the motor to pass through the liquid bath 220. The strip speed of the strip 240 of the core-sheath wire preform may range from 100 m/min to 1600 m/min. When this occurs, the metal layer of the heated portion 2401 of the strip 240 of the core-sheath wire preform is immediately brought into reaction (i.e., the oxidation reaction, see infra) with the dielectric liquid in the liquid bath 220 and cooled by the dielectric liquid.

### EXAMPLE 1

A sample identified as AY was constructed utilizing the system 200 described above and employing operating parameters as follows:
Dielectric Liquid (220)=Deionized Water
Metallic Core (110)=60 Cu/40 Zn Alloy˜244 μm dia
Metal Layer=Zinc˜3 μm thick
Wire Speed=1590 m/min
Current Drawn=39 amps

A metallurgical cross-section of the sample A_{γ} is illustrated in FIG. 2. In a manner similar to a hot dip zinc deposition process, two events occurred simultaneously when the wire is resistively heated. First, the zinc was oxidized, which produced an oxide layer estimated to be 2-3 μm thick. At the same time, a diffusion sublayer of gamma phase brass was formed, which was estimated to be 7-8 μm thick. In the construction of sample A_{γ}, the zinc layer was created by electrochemically depositing a zinc layer approximately 15.0 μm thick at a diameter of 1.2 mm onto the metallic core. The coated wire was then cold drawn to a finish diameter of 0.25 mm. The economics of the system 200 and the metallurgical sample A_{γ} it produced suggested a more viable approach would be to oxidize the zinc in the forming system 200 at the larger diameter of 1.2 mm and subsequently convert any residual zinc to gamma or beta phase prior to cold drawing the composite construction to a finish diameter of 0.25 mm.

That strategy was employed in the construction of sample BT which was processed in the forming system 200 using the process parameters as follows:

### EXAMPLE 2

A sample By was constructed using the system 200 and employing operating parameters as follows:
Dielectric Liquid=Deionized Water
Metallic Alloy Core=60 Cu/40 Zn, 1.2 mm diameter
Metal Layer=Zinc, 15 μm thick
Wire Speed=300 m/min
Current Draw=93 amps,

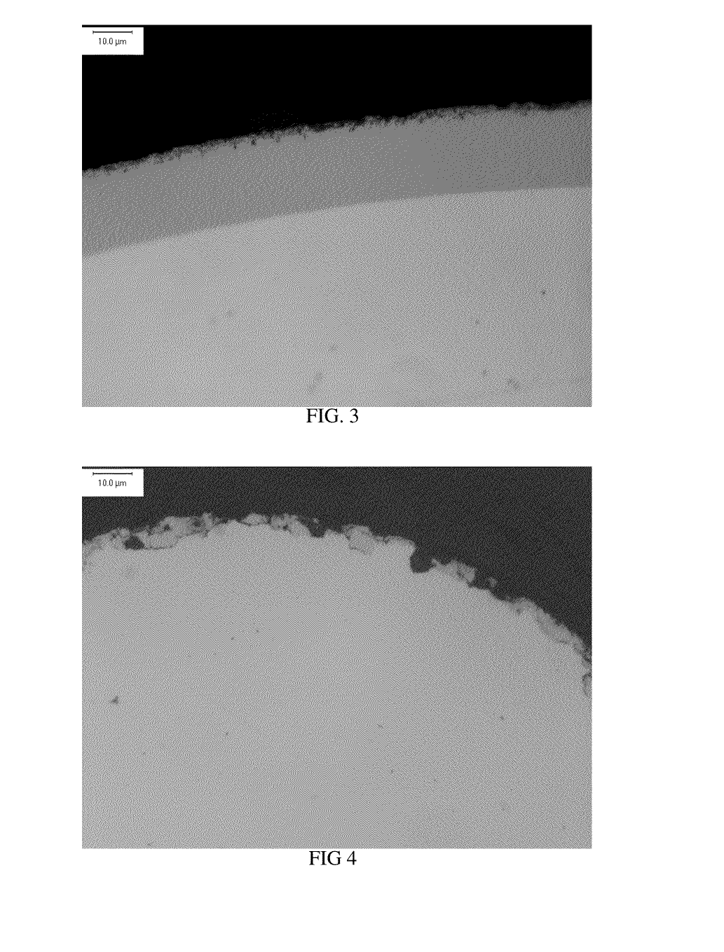

A metallurgical cross-section of sample BY after a post oxidation heat treatment of 177° C. for 4 hrs is illustrated in FIG. 3. The oxide thickness is approximately the same as that of sample A_{γ}, but the gamma phase thickness increased to 18-20 μm. The 177° C. post-oxidation heat in air was used to convert any residual zinc to gamma phase prior to cold drawing. The resultant as drawn, microstructure is illustrated in FIG. 4. When the sample B_{γ} was drawn to a finish diameter of 0.25 mm the gamma phase fractures as expected. However, in the process of redistributing the fractured gamma phase panicles around the circumference it also appears to agglomerate the oxide forming large particles, which can be up to 7 or 8 μm in breath.

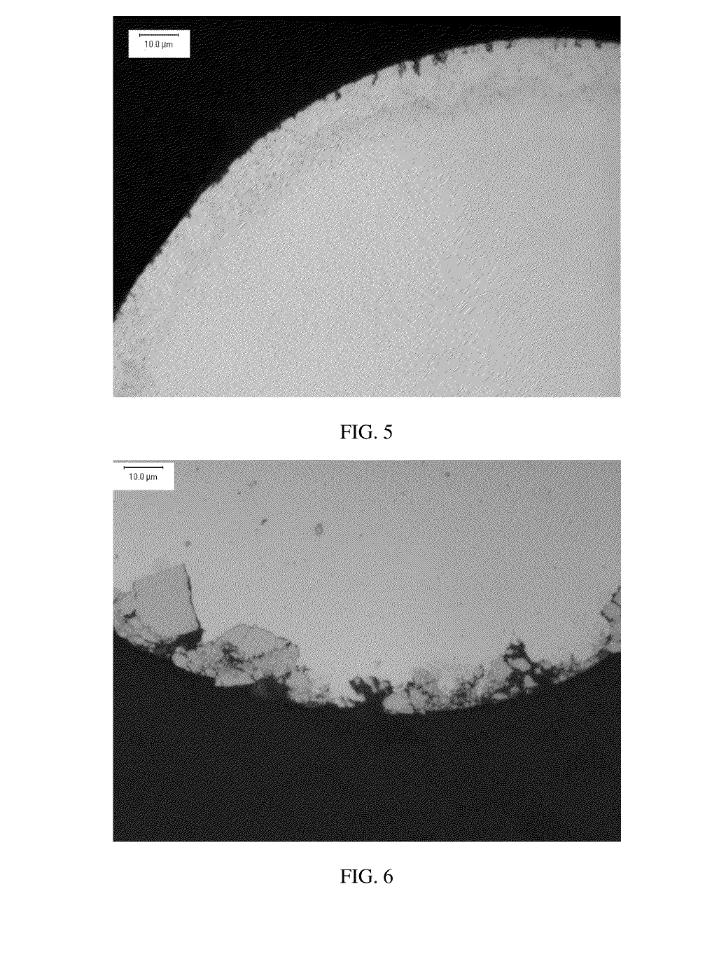

In a similar manner, a sample identified as B_{β} (shown in FIG. 5) was constructed under the same process conditions as B_{γ} except that the post-oxidation heat treatment was 670° C. for 1.2 hrs in air. The microstructure shown in FIG. 5 illustrates the sample By after cold drawing to a finish diameter of 0.25 mm. This heat treatment converted any gamma phase formed simultaneously with the oxide and any excess zinc remaining after the oxidation process to beta phase.

Since beta phase is not as brittle as gamma phase it did not fracture, forming discrete particulate in contrast to the behavior of gamma phase when the wire is drawn to its 0.25 mm finish diameter. The beta phase therefore forms a continuous substrate under the oxide and there was no agglomeration of surface oxide into larger particles. Rather, the surface oxide remained in a morphology closely resembling the size of the oxide after it was transformed. However, since oxides are typically also brittle, they will fracture and be forced to redistribute around the circumference as new surface area is created by the plastic deformation during drawing. Although it is difficult to discern the oxide particles in FIGS. 2-6 when photographed, they are readily apparent, when viewed in a metallographic microscope at 1000× with the naked eye and the conclusions in comparing them are the same as those stated here.

### EXAMPLE 3

Performing the zinc oxidation treatment at an intermediate diameter resulted in retaining large oxide particles, which axe believed to be advantageous in enhancing, the flushing aspect of the EDM. The oxidation parameters were further altered to enhance the piezoelectric responsiveness of the oxide. To this end, the sample C_{γ} was constructed using the forming system 200 and employing operating parameters as follows:
Dielectric Liquid=Deionized Water
Metallic Alloy Core=60 Cu/40 Zn, 1.2 mm diameter
Metal Layer=Zinc, 15 μm thick
Wire Speed=180 m/min
Current Draw=98 amps.

The excess zinc in the sample C_{γ} resulting from the oxidation process was converted to gamma phase by subjecting the sample to a post-oxidation heat treatment of 177° C. for 4 hrs in air prior to cold drawing to a finish diameter of 0.25 mm. FIG. 6 illustrates the microstructure developed by this construction. The gamma phase particles appeared to be somewhat larger than those observed in the sample B_{γ} although the retained oxide particles appeared to have a similar morphology and a possibly more frequent occurrence in the sample C_{γ} than those of the sample B_{γ}. The true value of these processing sequences was best determined by subjecting the various samples to a performance test on an EDM machine tool.

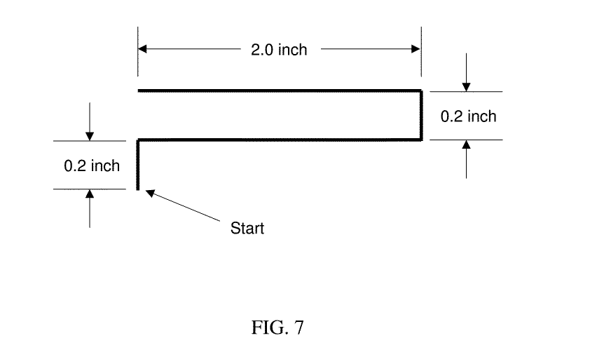

This was accomplished on an Excetek machine tool Model W500G using the following procedure. The test cut described in FIG. 7 was performed on a 2.0 inch thick D-2 tool steel work piece hardened to Re 56-60. To determine the appropriate machine technology for each wire type, an initial straight line test cut was performed under ideal flush conditions starting with Technology No. 1551 (2 inch SKD, 0.25 mm wire, 1 pass) with the technology being adjusted to achieve maximum cutting speed just prior to wire breakage. A wire tension of 1400 gm and water impedance of 10 microsiemens was used for all cuts. The test cut was then performed in an isolated region of the work piece where it could be initiated under ideal flush conditions.

The results of these performance tests are summarized in the Table. For the purpose of comparison, data was also determined for a standard brass wire and for Thermocompact SD wire, which is a gamma wire type made under a license for U.S. Pat. No. 5,945,010 and Cobra Cut D, which is “Diffusion Annealed” Wire Type and has an 80 Cu/20 Zn brass core with a beta phase brass coating.

TABLE

| | Time (min) | Cutting Speed | Relative to | Relative to |
|---|---|---|---|---|
| Wire Type | for 2.4″ cut | (mm/min) | γ-Speed | β-Speed |
| Standard Brass | 24.800 | 2.46 | 24.0% | 39.7% |
| Cobra Cut D | 17.750 | 3.43 | | 0.0% |
| Thermocompact | 20.000 | 3.05 | 0.0% | |
| SD | | | | |
| A_{γ} | 19.250 | 3.17 | (3.8%) | |
| B_{γ} | 17.767 | 3.43 | (11.2%) | |
| B_{β} | 17.983 | 3.39 | | 1.3% |
| C_{γ} | 16.333 | 3.73 | (18.3%) | |
| C_{β} | 17.050 | 3.58 | | (3.9%) |

The last two columns are the cutting speeds relative to that of a state of the art gamma type wire, e.g., Thermocompact SD, and state of the art beta type wire, e.g., Cobra Cut D. As would be expected, the state of the art wire types are significantly faster than a common brass wire. It is clear, however, that all of the wires with a piezoelectric responsive surface coating outperformed their appropriate state of the art wire type. This occurred in increasingly significant margins as the process conditions were optimized for zinc oxide retention. Based on the metallographic characterization of these wires, it is estimated that the zinc oxide particle size ranged between several microns and up 6-7 microns.

The present invention constructions of wire types with a piezoelectric responsive element on the surface produced in the provided examples contained a microstructure with a sublayer of semi-continuous gamma phase brass or a sublayer of continuous beta phase brass. These sublayers, however, are not required to achieve the advantage of a piezoelectric responsive element as evidenced by the data of the Table. All of the piezoelectric responsive samples outperformed the state of the art counterparts of their construction. The improved performance can therefore be attributed to the piezoelectric responsive element of the construction.

The morphology of the ZnO piezoelectric element of the examples presented here are distinctly different than the ZnO thin film semi-conductive element described in the prior art. By necessity the ZnO thin film semi-conductive element is considerably thinner (less than 1000 to hundreds of nm) and is continuous as compared to the ZnO piezoelectric element of the present invention, which are closer to an order of magnitude larger and generally semi or discontinuous depending on where they are created in the wire fabrication process.

It is probable there are zinc-free piezoelectric responsive compounds that are of interest to the EDM application, such as aluminum nitride, which may be continuous at some point in the fabrication of an EDM wire but more probably will be discontinuous as fabricated. These compounds are useful in aerospace and medical applications.

While this invention has been described as having a preferred design, the present invention can be further modified within the spirit and scope of this disclosure. This application is therefore intended to cover any variation, uses, or adaptations of the invention using its general principles. Further, this application is intended to cover such departures from the present disclosures as come within known and customary practice in the art which this invention pertains and which fall within the appended claims.

What is claimed is:

1. An electrode wire for use in an electric discharge machining apparatus comprising:
a metallic core; and
a piezoelectric responsive coating disposed on the core.

2. The electrode wire of claim 1, wherein the core comprises copper

3. The electrode wire of claim 1, wherein the core comprises a copper zinc alloy.

4. The electrode wire of claim 1, wherein the core comprises copper clad steel.

5. The electrode wire of claim 1, wherein the core comprises aluminum clad steel.

6. The electrode wire of claim 1, wherein the core comprises one of a metal and a metal alloy.

7. The electrode wire of claim 1, wherein the piezoelectric responsive coating comprises zinc oxide.

8. The electrode wire of claim 1, wherein the piezoelectric responsive coating comprises a layer of zinc oxide with a thickness greater than 1 μm.

9. The electrode wire of claim 1, wherein the piezoelectric responsive coating comprises a layer of aluminum nitride.

10. The electrode wire of claim 1, wherein the piezoelectric responsive coating comprises discontinuous zinc oxide particles with a thickness greater than 1 μm.

11. An electrode wire for use in an electric discharge machining apparatus comprising:
a metallic core;
an intermediate brass alloy layer disposed on the core and having a zinc content greater than 40 weight per cent; and
a piezoelectric responsive coating disposed on the intermediate brass alloy layer.

12. The electrode wire of claim 11, wherein the core comprises copper.

13. The electrode wire of claim 11, wherein the core comprises a copper zinc alloy.

14. The electrode wire of claim 11, wherein the core comprises one of a metal and a metal alloy.

15. The electrode wire of claim 11, wherein the intermediate brass alloy layer is beta phase brass.

16. The electrode wire of claim 11, wherein the intermediate brass alloy layer comprises gamma phase brass.

17. The electrode wire of claim 11, wherein the intermediate brass alloy layer comprises a semi-continuous layer of gamma phase brass alloy particles.

18. The electrode wire of claim 11, wherein the intermediate brass alloy layer comprises a continuous layer of beta phase brass alloy.

19. The electrode wire of claim 11, wherein the piezoelectric responsive coating comprises zinc oxide.

20. The electrode wire of claim 11, wherein the piezoelectric responsive coating comprises a layer of zinc oxide with a thickness greater than 1 μm.

21. The electrode wire of claim 11 wherein the piezoelectric responsive coating comprises a layer of aluminum nitride.

22. The electrode wire of claim 11, wherein the piezoelectric responsive coating comprises discontinuous zinc oxide particles with a thickness greater than 1 μm.

23. A process for producing a wire EDM machine tool electrode comprising:
providing a metallic core;
covering the core with a layer of zinc using an electrolytic process in order to produce a preblank;
wire drawing the preblank to reduce its diameter; and
resistively annealing the wire-drawn preblank in a dielectric water bath at a speed and electrical current configured to produce a gamma phase brass layer over the core and oxidize the zinc into a ZnO coating over the brass layer with a minimum thickness of 2 μm.

24. A process for producing a wire EDM machine tool electrode comprising:
providing a metallic core;
covering the core with a layer of zinc using an electrolytic process in order to form a preblank;
subjecting the preblank to a first wire drawing operation to reduce its diameter to an intermediate diameter;
resistively annealing the wire-drawn preblank in a dielectric water bath at a speed and electrical current configured to produce one of a gamma phase brass layer and a beta phase brass layer over the core as well as oxidize the zinc into a ZnO coating over the brass layer with a minimum thickness of 2 μm; and
subjecting the preblank to a second wire drawing operation to reduce its diameter to one appropriate for a wire EDM machine tool electrode.
